(19) United States
(12) Patent Application Publication
(10) Pub. No.: US 2001/0042019 A1
(43) Pub. Date: Nov. 15, 2001

(54) Commercial message transmitting and receiving system and commercial message transmitting and receving method using same

(75) Inventor: Takao Omachi, Tokyo (JP)

Correspondence Address: Norman P. Soloway, HAYES, SOLOWAY,HENNESSEY, GROSSMAN & HAGE, P.C., 175 Canal Street, Manchester, NH, 03101, US

(73) Assignee: NEC Corporation

(21) Appl. No.: 09/855,971

(22) Filed: May 15, 2001

(30) Foreign Application Priority Data
May 15, 2000 (JP) 141827/2000

(51) Int. Cl. G06F 17/60

(52) U.S. Cl. 705/14

(57) ABSTRACT

A Commercial Message (CM) transmitting and receiving system which allows an advertiser to obtain an expanded advertisement effect regardless of types of broadcasting during a same time period and allows a viewer to easily select, of his/her own will, a CM. In an advertiser terminal, two pieces of CM/ID information corresponding to CM materials are distributed. In a broadcasting terminal, a scaled-down image and multi-channeled voices are generated and two pieces of CM/ID information are synthesized. In a transmitting device, the scaled-down and synthesized image, multi-channeled voices and two pieces of CM/ID information are output. In a receiving terminal, based on two pieces of CM/ID information and attribute information of viewers, one CM material is automatically or manually selected.

### BACKGROUND OF THE INVENTION

1. Field of the Invention

The present invention relates to a CM (Commercial Message) transmitting and receiving system to transmit and receive CM materials and a CM transmitting and receiving method using the same.

The present application claims priority of Japanese Patent Application No. 2000-141827 filed on May 15, 2000, which is hereby incorporated by reference.

2. Description of the Related Art

In a conventional CM transmitting and receiving system, since it cannot send and receive only one CM during one time period, an advertiser can choose but distribute the CM specifically targeted at specified viewers or distribute the CM of an image advertising kind, without being specifically targeted at any specified viewer.

Moreover, the advertiser, since he/she cannot obtain feedback information from the viewer in real time, cannot know what kind of the viewer watches CMs with interest. This makes it difficult for the advertiser to run a simultaneous and effective advertisement being targeted at a plurality of viewers each having a different interest.

In recent years, various systems have been proposed to solve problems described above. For example, an advertisement information broadcasting system is disclosed, for example, in Japanese Patent Application Laid-open No. Hei 11-17633, which includes a transmitting device adapted to distribute a CM with a target ID (Identification) added to identify the viewer and in a state where the CM is multiplexed in broadcasting signals and a receiving terminal adapted to receive broadcasting signals distributed by the transmitting device and to select and receive advertisement information in which the target ID contained in the broadcasting signals agrees with attributes of the viewer registered in advance.

In the above advertisement information broadcasting system, the transmitting device is so configured as to distribute the advertisement information with detailed information being more detailed than the advertisement information attached to the advertisement information and the receiving terminal is so configured as to allow the detailed information to be watched when a viewer wants to see the detailed information and to allow a history of requests for the detailed information to be uploaded to the transmitting device.

This allows the viewer selectively to watch only his/her favorite advertisement information and also the advertiser to run the advertisement effectively for the viewer who has an interest in the advertisement information and allows collection of a history of the advertisement information, thus achieving more effective advertisement.

However, the above conventional technology has problems. That is, in the above conventional advertisement information broadcasting system disclosed in Japanese Patent Application Laid-open No. Hei 11-17633, since the advertisement information is output only in the receiving terminal in which the target ID of the advertisement information agrees with the attributes of the viewer, the advertiser who distributes the advertisement information cannot obtain simultaneous advertisement effects from receiving terminals having a different attribute of the viewer during a same time period, as a result, causing unsatisfactory advertisement effects.

Moreover, the viewer of the receiving terminal is not allowed to select, of his/her own will, the advertisement information unless the attributes of the viewer already registered in advance on the receiving terminal are changed.

Furthermore, a target for the above apparatus is digital broadcasting only and no consideration has been given to analog broadcasting.

### SUMMARY OF THE INVENTION

In view of the above, it is an object of the present invention to provide a CM transmitting and receiving system and a CM transmitting and receiving method using the CM transmitting and receiving system which allow an advertiser to obtain expanded advertisement effects regardless of types of broadcasting during a same time period and allow a viewer to easily select, of his/her own will, a CM that he/she desires to receive.

According to a first aspect of the present invention, there is provided a CM transmitting and receiving system for transmitting and receiving CM materials including:

an advertiser terminal to distribute a plurality of the CM materials and a plurality of pieces of CM/ID information each corresponding to each of a plurality of the CM materials over a same channel and during a same time period;

a broadcast station terminal to create and output a scaled-down and synthesized image obtained by scaling down and synthesizing each of images of a plurality of the CM materials and multi-channeled voices obtained by assigning each of voices of a plurality of the CM materials to a plurality of voice channels each being different from each other and, at a same time, to synthesize and output a plurality of pieces of the CM/ID information;

a transmitting device to modulate the scaled-down and synthesized image and multi-channeled voices fed from the broadcast station terminal and to transmit them as program data and, at a same time, to modulate and transmit a plurality of pieces of the CM/ID information fed from the broadcast station terminal;

a receiving terminal to automatically select, based on a plurality of pieces of the CM/ID information transmitted from the transmitting device and attribute information of a viewer input in advance, one CM material out of a plurality of pieces of the CM information fed as the scaled-down and synthesized image from the transmitting device and to expand and display images of the CM materials automatically selected out of a plurality of the CM materials contained in the scaled-down and synthesized images and, at a same time, to output voices of the voice channels of the CM materials automatically selected out of a plurality of the voice channels contained in the multi-channeled voices.

In the foregoing, a preferable mode is one wherein the receiving terminal transmits the CM/ID information of the CM material and attribute information of the viewer automatically selected to the advertiser terminal through a network and wherein the advertiser terminal performs statistical processing of the CM/ID information transmitted from the transmitting device and attributes of the viewer.

According to a second aspect of the present invention, there is provided a CM transmitting and receiving system to transmit and receive CM materials including;

an advertiser terminal to distribute a plurality of the CM materials and a plurality of pieces of CM/ID information each corresponding to each of the plurality of the CM materials over a same channel and during a same time period;

a broadcast station terminal to create and output a scaled-down and synthesized image obtained by scaling down and synthesizing each of images of the plurality of the CM materials and multi-channeled voices obtained by assigning each of voices of the plurality of the CM materials to a plurality of voice channels each being different from each other and, at a same time, to synthesize and output the plurality of pieces of the CM/ID information;

a transmitting device to modulate the scaled-down and synthesized image and the multi-channeled voices fed from the broadcast station terminal and to transmit them as program data and, at a same time, to modulate and transmit the plurality of pieces of the CM/ID information fed from the broadcast station terminal; and

a receiving terminal to display the scaled-down and synthesized image transmitted from the transmitting device and to expand and display, when one CM material out of the plurality of the CM materials contained in the scaled-down and synthesized images is selected, images of the CM material manually selected and, at a same time, to output voices of the voice channels of the CM materials manually selected out of the plurality of voice channels contained in the multi-channeled voices.

Also, a preferable mode is one wherein the receiving terminal transmits the CM/ID information of the CM material and attribute information of the viewer manually selected to the advertiser terminal through the network and wherein the advertiser terminal performs statistical processing of the CM/ID information transmitted from the transmitting device and attributes of the viewer.

Also, a preferable mode is one wherein the transmitting device, when the scaled-down and synthesized image and multi-channeled voices are transmitted by analog broadcasting, transmits the CM/ID information by using a VBI (Vertical Blanking Interval) and, when the scaled-down and synthesized image and multi-channeled voices are transmitted by digital broadcasting, transmits the CM/ID information as section information or PES (Packetized Elementary Stream) information.

Also, a preferable mode is one wherein the receiving terminal comprises:

a viewer attribute setting section to store attribute information of the viewer input in advance;

a viewer attribute processing section to select one CM material out of the plurality of the CM materials transmitted as the scaled-down and synthesized image and multi-channeled voices from the transmitting device;

an image cutting/expanding section to cut and expand images of the CM materials selected by the viewer attribute processing section out of images of the plurality of the CM materials contained in the scaled-down and synthesized transmitted from the transmitting device;

a voice channel selecting section to select voice channels of the CM materials selected by the viewer attribute processing section out of the plurality of the voice channels contained in the multi-channeled voices transmitted from the transmitting device;

a switching section to select either of the scaled-down synthesized images transmitted from the transmitting device or images out of images output from the image cutting/expanding section;

a display to display images output from the switching section;

a speaker to output voices of the voice channels selected by the voice channel selecting section;

a selected CM database to store the CM/ID information of the CM materials and attributes of viewers selected by the viewer attribute processing section; and

a communication section to transmit the CM/ID information and attributes of viewers stored in the selected CM database to the advertiser terminal through the network.

Also, a preferable mode is one wherein the viewer attribute processing section is able to automatically and manually select one CM material out of the plurality of the CM materials transmitted as the scaled-down and synthesized image and multi-channeled voices from the transmitting device, based on the plurality of pieces of CM/ID information transmitted from the transmitting device and attributes of viewers stored in the viewer attribute setting section.

Also, a preferable mode is one wherein the advertiser terminal has a statistical processing section of performing statistical processing of the CM/ID information and attributes of viewers transmitted from the communication section through the network.

According to a third aspect of the present invention, there is provided a CM transmitting and receiving method, including:

a step of distributing a plurality of CM materials and a plurality of pieces of CM/ID information each corresponding to each of the plurality of the CM materials over a same channel and during a same time period from an advertiser terminal to a broadcast station terminal;

a step of scaling down and synthesizing each of the plurality of the CM materials to create scaled-down and synthesized images in the broadcast station terminal and outputting the scaled-down and synthesized image to a transmitting device;

a step of assigning each of voices of the plurality of the CM materials to voice channels each being different from each other to create multi-channeled voices in the broadcast station terminal and of outputting multi-channeled voices to the transmitting device;

a step of synthesizing the plurality of pieces of the CM/ID information in the broadcast station terminal and of outputting them;

a step of modulating, in the transmitting device, the scaled-down and synthesized image and multi-channeled voices fed from the broadcast station terminal and transmitting as program data to the receiving terminal and modulating the plurality of pieces of the CM/ID information fed from the broadcast station terminal and outputting them to the receiving terminal;

a step of automatically selecting one CM material out of the plurality of pieces of the CM information transmitted as the scaled-down and synthesized image and multi-channeled voices from the transmitting device, based on attribute information of viewers and the plurality of pieces of the CM/ID information input in advance in the receiving terminal; and

a step of expanding and displaying images of the CM materials automatically selected out of images of the plurality of the CM materials contained in the scaled-down and synthesized images in the receiving terminal and of outputting voice channels of the CM materials automatically selected out of the plurality of the voice channels contained in the multi-channeled voices.

Also, a preferable mode is one that wherein further includes:

a step of storing the CM/ID information of the CM materials and attributes of viewers automatically selected by the receiving terminal;

a step of transmitting the CM/ID information of the CM materials, attributes of viewers automatically selected by the receiving terminal to the advertiser terminal through the network; and

a step of performing statistical processing of the CM/ID information and attributes of viewers transmitted from the receiving terminal in the advertiser terminal.

A preferable mode is one that wherein still includes:

a step of storing the CM/ID information of the CM materials and attributes of viewers manually selected by the receiving terminal;

a step of transmitting the CM/ID information of the CM materials and attributes of viewers manually selected by the receiving terminal to the advertiser terminal through the network; and

a step of performing statistical processing of the CM/ID information and attributes of viewers transmitted from the receiving terminal in the advertising terminal.

Furthermore, a preferable mode is one wherein the transmitting device, when the scaled-down and synthesized image and multi-channeled voices are transmitted by analog broadcasting, transmits the CM/ID information by using the VBI and, when the scaled-down and synthesized image and multi-channeled voices are transmitted by digital broadcasting, transmits the CM/ID information as section information or as PES information.

Also, according to a fourth aspect of the present, there is provided a CM transmitting and receiving method includes:

a step of distributing the plurality of the CM materials and the plurality of pieces of the CM/ID information each corresponding to each of the plurality of the CM materials over a same channel and during a same time period from the advertiser terminal to the broadcast station terminal;

a step of scaling down and synthesizing each of the plurality of the CM materials to create scaled-down and synthesized in the broadcast station terminal and of outputting the scaled-down and synthesized image to the transmitting device;

a step of assigning each of voices of the plurality of the CM materials to the voice channels each being different from each other to create multi-channeled voices in the broadcast station terminal and of outputting the multi-channeled voices to the transmitting device;

a step of synthesizing the plurality of pieces of the CM/ID information in the broadcast station terminal and of outputting them;

a step of modulating, in the transmitting device, the scaled-down and synthesized image and multi-channeled voices fed from the broadcast station terminal and transmitting as program data to the receiving terminal and modulating the plurality of pieces of the CM/ID information fed from the broadcast station terminal and outputting them to the receiving terminal;

a step of synthesizing the plurality of pieces of the CM/ID information in the broadcast station terminal and of outputting them;

a step of modulating, in the transmitting device, the scaled-down and synthesized image and multi-channeled voices fed from the broadcast station terminal and transmitting as program data to the receiving terminal and modulating the plurality of pieces of the CM/ID information fed from the broadcast station terminal and outputting them to the receiving terminal;

a step of displaying the scaled-down and synthesized image in the receiving terminal;

a step of manually selecting one CM material out of the plurality of the CM materials contained in the scaled-down and synthesized displayed by the receiving terminal; and

a step of expanding images of the CM materials manually selected out of images of the plurality of the CM materials contained in the scaled-down and synthesized image and of outputting voices of the voice channels of the CM materials manually selected out of the plurality of the voice channels contained in the multi-channeled voices.

With the above configuration, in the advertiser terminal, the plurality of pieces of the CM/ID information each corresponding to each of the plurality of the CM materials is distributed over the same channel and during the same time period and, in the receiving terminal, based on the plurality of pieces of the CM/ID information and attributes of the viewer input in advance, one CM material out of the plurality of the CM materials distributed from the advertiser terminal is automatically selected, expanded and displayed and, at the same time, the voice of the CM material is output, thus enabling the viewer of the receiving terminal to selectively receive his/her favorite CM materials.

With another configuration, the advertiser using the advertiser terminal can improve advertisement and investment effects more then when compared with a case in which a same CM material is distributed to all the viewers regardless of the attributes of the viewers and can improve more advertisement and investment effects that can be obtained during the same time period, thus achieving sufficiently satisfactory advertisement and investment effects.

With still another configuration, in the receiving terminal, the scaled-down and synthesized image obtained by scaling down and synthesizing the image of the plurality of the CM materials is displayed and, when one CM material out of the plurality of the CM materials contained in the scaled-down and synthesized images is manually selected, the CM material manually selected is expanded and displayed and, at the same time, the voice of the CM materials is output, thus enabling the viewer of the receiving terminal, of his/her own will, to select the CM material.

With still another configuration, in the receiving terminal, since the CM/ID information selected manually or automatically and attributes information of the viewer is automatically transmitted to the advertiser terminal through the network, the advertiser terminal can perform statistical processing of the CM/ID information of the CM material transmitted from the receiving terminal and attributes of the viewer which allows the advertiser using the advertiser terminal to obtain information about types of the CM and attributes of the viewer.

With still another configuration, in the transmitting terminal, when the scaled-down and synthesized image and multi-channeled voices are transmitted by analog broadcasting, the CM/ID information is transmitted using the VBI and, when the scaled-down image and multi-channeled voices are transmitted by digital broadcasting, the CM/ID information is transmitted as the section information or as the PES information, thus enabling the advertiser of the advertiser terminal to obtain advertisement and investment effects regardless of types of broadcasting.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing configurations of a CM transmitting and receiving system according to an embodiment of the present invention;

FIG. 2 is a diagram showing one example of a scaled-down and synthesized image to be created by a scaling-down/synthesized system in FIG. 1;

FIG. 3 is a flowchart explaining one example of a CM transmitting and receiving method using the CM transmitting and receiving system shown in FIG. 1; and

FIG. 4 is a flowchart explaining an other example of the CM transmitting and receiving method using the CM transmitting and receiving system shown in FIG. 1.

### DETAILED DESCRIPTION OF THE PREFERRED EMBODIMENTS

Best modes of carrying out the present invention will be described in further detail using one embodiment with reference to the accompanying drawings.

### Embodiment

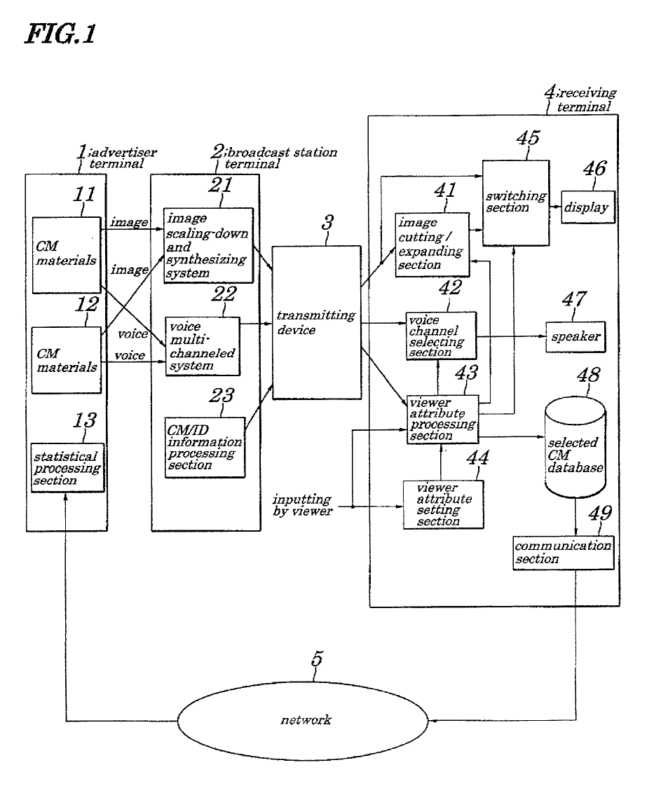

FIG. 1 is a schematic block diagram showing configurations of a CM transmitting and receiving system according to an embodiment of the present invention. The CM transmitting and receiving system of the embodiment shown in FIG. 1 is made up of an advertiser terminal 1 used to distribute two CM materials 11 and 12 and two pieces of CM/ID information corresponding to the CM materials 11 and 12 respectively over a same channel and during a same time period, a broadcast station terminal 2 used to create and output a scaled-down and synthesized image obtained by scaling down and synthesizing images each corresponding to each of the two CM materials 11 and 12 distributed by the advertiser terminal 1 and to create and output multi-channeled voices obtained by assigning each of voices of the two CM materials 11, 12 distributed by the advertiser terminal 1 to two voice channels being different from each other and to synthesize and output CM/ID information distributed by the advertiser terminal 1, a transmitting device 3 used to modulate the scaled-down and synthesized image and the multi-channeled voices output from the broadcast station terminal 2 and to send them out as program data and used to modulate the CM/ID information output from the broadcast station terminal 2 and to send them out and a receiving terminal 4 used to automatically or manually select one of CM materials out of the CM materials 11 and 12 transmitted out as the scaled-down and the multi-channeled voices from the transmitting device 3 and to expand and display images of the CM materials selected out of the CM materials 11 and 12 contained in the scaled-down and synthesized images transmitted out from the transmitting device 3 and to output voices of the voice channel of the CM materials selected from voice channels of the CM materials 11 and 12 contained in the multi-channeled voices transmitted out from the transmitting device 3 and used to automatically transmit the CM/ID information of the selected CM materials and attribute information of viewers through a network 5 and, in the advertiser terminal 1, statistical processing of the CM/ID information of the CM materials and information about attributes of the viewer is performed.

Moreover, in the example of the embodiment, it is assumed that the advertiser terminal 1 distributes two CM materials 11 and 12, however, the number of the CM materials distributed by the advertiser terminal 1 is not limited to two so long as it is a plural number.

The advertiser terminal 1 is made up of the CM materials 11 and 12 and a statistical processing section 13 to perform statistical processing of the CM/ID information of the CM materials and information about attributes transmitted from the receiving terminal 4.

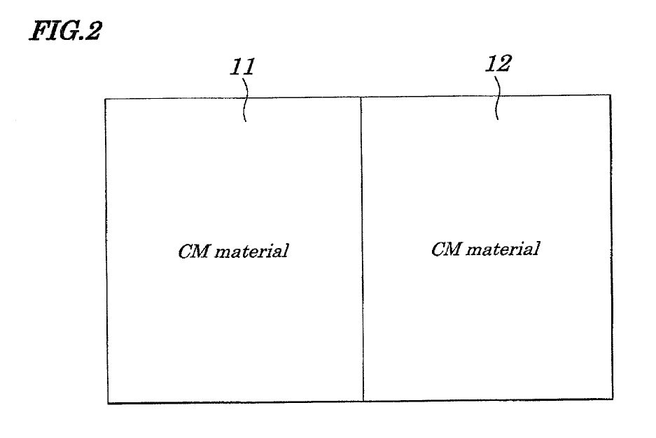

The broadcast station terminal 2 is made up of an image scaling-down and synthesizing system used to create and output the scaled-down and synthesized images shown in FIG. 2 by scaling down and synthesizing images of each of the CM materials 11 and 12, a voice multi-channeled system 22 used to create and output the multi-channeled voices by assigning each of the CM materials 11 and 12 to two voice channels being different from each other and a CM/ID information processing section 23 used to synthesize and output the two CM/ID information distributed from the advertiser terminal 1.

Moreover, the CM/ID information of the CM material includes information used to identify a CM itself, information about an attribute of a viewer who is desired to watch the CM or a like. That is, the CM/ID information of the CM material includes information that, for example, a CM is used to advertise an automobile or information about, for example, a type of the automobile for which the CM is created.

Furthermore, the voice channel is equivalent, for example, to a main voice channel or a sub-voice channel for analog terrestrial broadcasting.

The receiving terminal 4 is made up of a viewer attribute setting section 44 used to store attribute information of a viewer input, in advance, by the viewer, a viewer attribute processing section 43 used to automatically or manually select one CM material out of two CM materials 11 and 12 transmitted as an scaled-down image and multi-channeled voices from the transmitting device 3, an image cutting/expanding section 41 used to cut and expand an image portion of the CM material selected by the viewer attribute processing section 43 out of images of the CM materials 11 and 12 contained in the scaled-down and synthesized images transmitted from the transmitting device 3, a voice channel selecting section 42 used to select the voice channel of the CM material selected by the viewer attribute processing section 43 out of voice channels of the CM materials 11 and 12 contained in the multi-channeled voices transmitted from the transmitting device 3, a switching section 45 used to select and output any one of images out of the scaled-down and synthesized images transmitted from the transmitting device 3 and images output from the image cutting/expanding section 41, a display 46 used to display images output from the switching section 45, a speaker 47 used to output a voice of the voice channel selected by the voice channel selecting section 42, a selected CM database 48 used to store the CM/ID information of the CM materials selected by the viewer attribute processing section 43 and attribute information of the viewer and a communication section 49 used to automatically transmit attribute information of the CM material stored in the selected CM database 48 and attribute information of the viewer to the advertiser terminal 1 through the network 5 such as the Internet.

The viewer attribute processing section 43, when automatically selecting one of the CM materials 11 and 12, selects one CM material based on attributes of the viewer stored in the viewer attribute setting section 44 and the two pieces of the CM/ID information transmitted from the transmitting device 3.

Moreover, the attribute information of the viewer includes information about fixed attributes of the viewer (such as an age, sex or a like) and about a preference of the viewer (such as the information about a type of an automobile or a like)

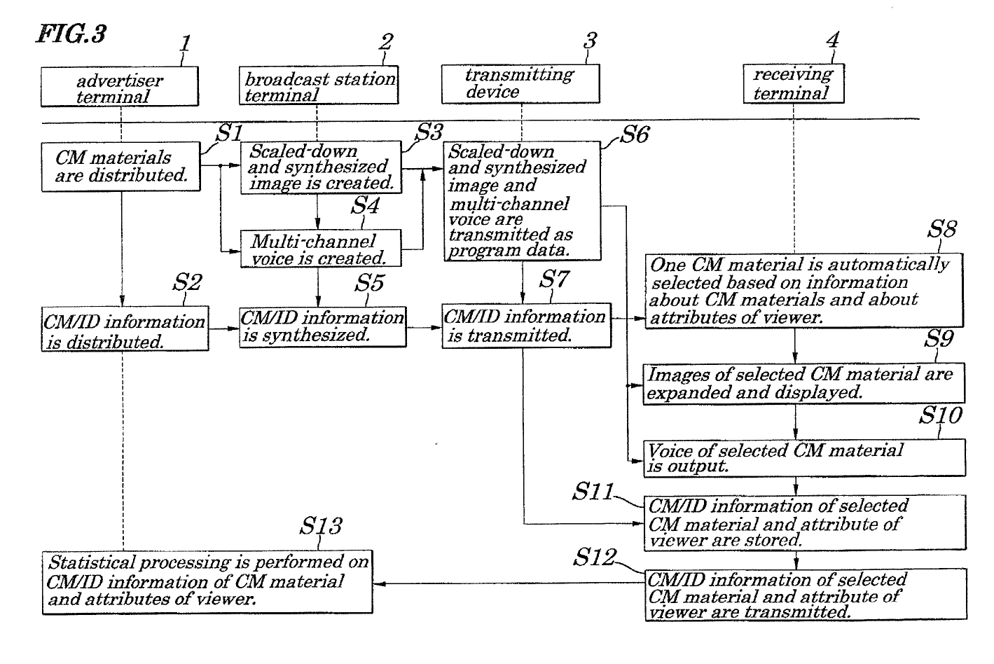

The CM transmitting and receiving method using the CM transmitting and receiving system configured as above will be described by referring to a flowchart in FIG. 3.

FIG. 3 is a flowchart explaining one example of the CM transmitting and receiving method using the CM transmitting and receiving system shown in FIG. 1. In the embodiment, it is assumed that the viewer attribute setting section 44 is so configured as to automatically select one CM out of the CM materials 11 and 12 transmitted from the transmitting device 3 and the switching section 45 is so configured as to select, all the time, images output from the image cutting/expanding section 41.

In the advertiser terminal 1, the two CM materials 11 and 12 are distributed over the same channel and during the same time period to the broadcast station terminal 2 (Step S1) and two pieces of the CM/ID information corresponding to the CM materials 11 and 12 respectively are distributed to the broadcast station terminal 2 (Step 32).

In the broadcast station terminal 2, the image scaling-down and synthesizing system 21 scales down and synthesizes each image of the CM materials 11 and 12 to create a scaled-down and synthesized image (see FIG. 2) and outputs it to the transmitting device 3 (Step S3). Moreover, the voice multi-channeled system 22 assigns each of voices of the CM materials 11 and 12 to two voice channels being different from each other to create multi-channeled voices and outputs it to the transmitting device 3 (Step S4). The CM/ID information processing section 23 synthesizes the two CM/ID information to output them to the transmitting device 3 (Step S5).

The transmitting device 3 modulates the scaled-down and synthesized image output from the image scaling-down and synthesizing system 21 and the multi-channeled voices output from the voice multi-channeled system 22 and transmits them as program data for use in terrestrial broadcasting and satellite broadcasting (Step S6). Moreover, the transmitting device 3 modulates the CM/ID information output from the CM/ID information processing section 23 and outputs it in a format being different from the scaled-down and synthesized image and the multi-channeled voices (Step S7).

In the transmitting device 3, for examples the scaled-down and synthesized image and multi-channeled voices are transmitted as an analog broadcast, the CM/ID information of the CM material is transmitted by using a VBI (Vertical Blanking Interval), while the scaled-down and synthesized image and multi-channeled voices are transmitted as a digital broadcast, the CM/ID information of the CM material is transmitted in a form of section information or as a PES (Packetized Elementary Stream).

In the receiving terminal 4, the scaled-down and synthesized image transmitted from the transmitting device 3 is received by the image cutting/expanding section 41, the multi-channeled voices transmitted from the transmitting device 3 is received by the voice channel selecting section 42 and the CM/ID information transmitted from the transmitting device 3 is received by the viewer attribute processing section 43. Moreover, in the transmitting device 3, the viewer attribute setting section 44 stores attributes of the viewer in advance.

In the viewer attribute processing section 43, a matching between attribute information of the viewer stored in the viewer attribute setting section 44 and the received CM/ID information is performed and, out of the two CM materials 11 and 12 (for example, two CMs of automobiles of different types) received, as the scaled-down synthesized image and multi-channeled voices, respectively, by the image cutting/expanding section 41 and the voice channel selecting section 42, one CM material that a viewer would prefer, is automatically selected, and the selected result is notified to the image cutting/expanding section 41, the voice channel selecting section 42 and the switching section 45 (Step S8).

In the image cutting/expanding section 41, image portions of the CM materials selected by the viewer attribute processing section 43 out of images of the CM materials 11 and 12 contained in the scaled-down and synthesized images transmitted from the transmitting device 3 are cut and expanded and the cut and expanded image is output to the switching section 45.

In the embodiment, since an output from the image cutting/expanding section 41 is set so as to be selected by the switching section 45, all the time, an image output from the image cutting/expanding section 41 is transmitted to the display 46 where it is expanded and displayed (Step S9).

In the voice channel selecting section 42, a voice channel of the CM materials selected by the viewer attribute processing section 43 out of voice channels of the CM materials 11 and 12 contained in the multi-channeled voices transmitted from the transmitting device 3 is selected and the selected voice channel is output through the speaker 47 (Step S10).

Next, the CM/ID information of the CM materials and information about attributes of the viewer selected by the viewer attribute processing section 43 is stored in the selected CM database 48 (Step S11) and, if a permission from the viewer is obtained by input of the viewer, the information stored in the selected CM database 48 is automatically transmitted to the advertiser terminal 1 through the communication section 49 and the network 5 (Step S12).

Then, in the statistical processing section 13 mounted in the advertiser terminal 1, statistical processing of the CM/ID information of the CM materials and attributes of the viewer transmitted from the communication section 49 is performed (Step S13).

An other example of the CM transmitting and receiving method using the CM transmitting and receiving system shown in FIG. 1 will be explained.

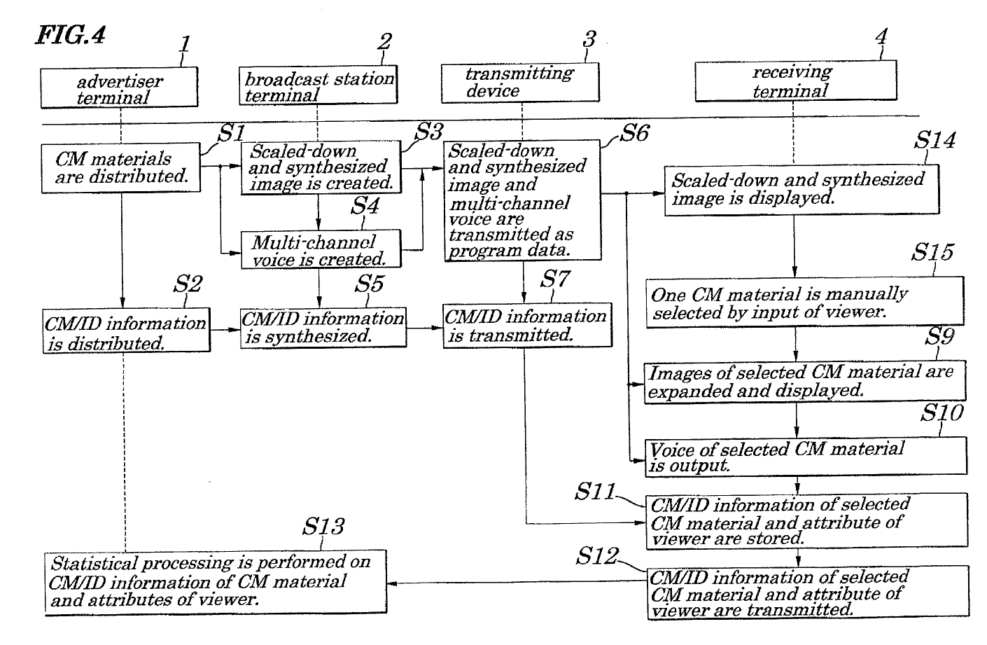

FIG. 4 is a flowchart explaining an other example of the CM transmitting and receiving method using the CM transmitting and receiving system shown in FIG. 1. In the embodiment, it is assumed that the viewer attribute processing section 43 is so configured as to manually select one CM out of the CM materials 11 and 12 transmitted from the transmitting device 3 and the switching section 45 selects the scaled-down and synthesized image transmitted from the transmitting device 3 and, when the result of the CM materials selected by the viewer attribute processing section 43 is notified, selects images output from the image cutting/expanding section 41. Moreover, processing in Steps S1 to S7 and Steps S9 to S13 in the embodiment shown in FIG. 4 is the same as in FIG. 3 and their descriptions are omitted accordingly.

When the processing in Steps S6 to S7 is terminated, the scaled-down and synthesized image transmitted from the transmitting device 3 is selected by the switching section 45 and is displayed on the display 46 (Step S14).

When the scaled-down and synthesized image is displayed on the display 46, one of CM materials out of the CM materials 11 and 12 contained in the scaled-down and synthesized images 11 and 12 is selected manually by input of the viewer in the viewer attribute processing section 43 (Step S15) and the result of selection of the CM material in the viewer attribute processing section 43 is notified to the image cutting/expanding section 41, voice channel selecting section 42, and switching section 45.

Then, as in the case of the embodiment in FIG. 3, processing in Steps S9 to S13 is performed.

In the embodiment, in order to obtain information about the preference of a viewer as an attribute of the viewer, the attribute information is input by the viewer himself/herself, however, according to the present invention, based on a history of watching programs (that is, the history shows what kind of the program is watched most frequently), information about the preference of the viewer can be automatically extracted.

As described above, in the embodiment, a plurality of CM materials and a plurality of pieces of the CM/ID information each corresponding to each of the plurality of the CM materials are distributed over a same channel and during a same time period and, in the receiving terminal 4, since the matching between a plurality of the CM/ID information and attribute information of the viewer is performed, one CM material out of the plurality of the CM materials is automatically selected, expanded and displayed and, at the same time, the voice of the CM materials is output.

This enables the advertiser using the advertiser terminal 1 to improve advertisement and investment effects more when compared with a case in which a same CM material is distributed to all the viewers regardless of the attributes of the viewer and to improve advertisement and investment effects more that can be obtained during a same time period when compared with the advertisement information broadcasting system disclosed in Japanese Patent Application Laid-open No. Hei 11-17633.

Moreover, in the receiving terminal 4, the scaled-down and synthesized image obtained by scaling down and synthesizing the image of the plurality of the CM materials is displayed and, when one CM material out of the plurality of the CM materials contained in the scaled-down and synthesized images is manually selected, the CM material manually selected is expanded and displayed and, at the same time, the voice of the CM materials is output, thus enabling the viewer of the receiving terminal 4, of his/her own will, to select the CM material. Also, in the receiving terminal 4, since the CM/ID information of the CM material and attributes of the viewer selected manually or automatically are transmitted to the advertiser terminal 1 through the network 5, the statistical processing section 13 mounted in the advertiser terminal 1 performs statistical processing of the CM/ID information of the CM material in real time.

Moreover, in the advertisement information broadcasting system disclosed in Japanese Patent Application Laid-open No. Hei 11-17633, a history of requesting for detailed information can be uploaded from the receiving terminal to the transmitting device, however, in the present invention, the viewer of the receiving terminal 4, after having watched the scaled-down and synthesized image, manually selects one CM material and can transmit the history of the selection of the CM material to the advertisement terminal 1, it is made possible for the advertiser of the advertiser terminal to perform the statistical processing of attributes of the viewer and the CM materials.

In the advertisement information broadcasting system disclosed in Japanese Patent Application Laid-open No. Hei 11-17633, the advertisement information is transmitted as data other than programs in a multiplexed form, however, in the present invention, since a plurality of images of the CM material is transmitted in the scaled-down and synthesized form as the program data being one CM frame, in the receiving terminal 4, a plurality of CM materials can be received simultaneously from a same advertiser over a same channel and during a same time period.

It is apparent that the present invention is not limited to the above embodiments but may be changed and modified without departing from the scope and spirit of the invention.

What is claimed is:

1. A commercial message transmitting and receiving system for transmitting and receiving commercial message materials comprising:
an advertiser terminal to distribute a plurality of said commercial message materials and a plurality of pieces of commercial message/identification information each corresponding to each of said plurality of said commercial message materials over a same channel and during a same time period;
a broadcast station terminal to create and output a scaled-down and synthesized image obtained by scaling down and synthesizing each of images of said plurality of said commercial message materials and multi-channeled voices obtained by assigning each of voices of said plurality of said commercial message materials to a plurality of voice channels each being different from each other and, at a same time, to synthesize and output said plurality of pieces of said commercial message/identification information;
a transmitting device to modulate said scaled-down and synthesized image and said multi-channeled voices fed from said broadcast station terminal and to transmit them as program data and, at a same time, to modulate and transmit said plurality of pieces of said commercial message/identification information fed from said broadcast station terminal;
a receiving terminal to automatically select, based on said plurality of pieces of said commercial message/identification information transmitted from said transmitting device and attribute information of a viewer input in advance, one commercial message material out of said plurality of pieces of said commercial message information fed as said scaled-down and synthesized image from said transmitting device and to expand and display images of said commercial message materials automatically selected out of said plurality of said commercial message materials contained in said scaled-down and synthesized images and, at a same time, to output voices of said voice channels of said commercial message materials automatically selected out of said plurality of said voice channels contained in said multi-channeled voices.

2. The commercial message transmitting and receiving system according to claim 1, wherein said receiving terminal transmits said commercial message/identification information of said commercial message material and said attribute information of said viewer automatically selected to said advertiser terminal through a network and wherein said advertiser terminal performs statistical processing of said commercial message/identification information transmitted from said transmitting device and said attribute information of said viewer.

3. The commercial message transmitting and receiving system according to claim 1, wherein said transmitting device, when said scaled-down and synthesized image and said multi-channeled voices are transmitted by analog broadcasting, transmits said commercial message/identification information by using a vertical blanking interval and, when said scaled-down and synthesized image and said multi-channeled voices are transmitted by digital broadcasting, transmits said commercial message/identification information as section information or packetized elementary stream information.

4. The commercial message transmitting and receiving system according to claim 2, wherein said receiving terminal comprises:
a viewer attribute setting section to store said attribute information of said viewer input in advance;
a viewer attribute processing section to select one commercial message material out of said plurality of said commercial message materials transmitted as said scaled-down and synthesized image and said multi-channeled voices from said transmitting device;
an image cutting/expanding section to cut and expand images of said commercial message materials selected by said viewer attribute processing section out of images of said plurality of said commercial message materials contained in said scaled-down and synthesized image transmitted from said transmitting device;
a voice channel selecting section to select voice channels of said commercial message materials selected by said viewer attribute processing section out of said plurality of said voice channels contained in said multi-channeled voices transmitted from said transmitting device;
a switching section to select either of said scaled-down synthesized images transmitted from said transmitting device or said images out of images output from said image cutting/expanding section;
a display to display images output from said switching section;
a speaker to output voices of said voice channels selected by said voice channel selecting section;
a selected commercial message database to store said commercial message/identification information of said commercial message materials and said attribute information of said viewers selected by said viewer attribute processing section; and
a communication section to transmit said commercial message/identification information and said attribute information of said viewers stored in said selected commercial message database to said advertiser terminal through said network.

5. The commercial message transmitting and receiving system according to claim 4, wherein said viewer attribute processing section is able to automatically and manually select one commercial message material out of said plurality of said commercial message materials transmitted as said scaled-down and synthesized image and said multi-channeled voices from said transmitting device, based on said plurality of pieces of said commercial message/identification information transmitted from said transmitting device and said attribute information of said viewers stored in said viewer attribute setting section.

6. The commercial message transmitting and receiving system according to claim 4, wherein said advertiser terminal has a statistical processing section of performing statistical processing of said commercial message/identification information and said attribute information of said viewers transmitted from said communication section through said network.

7. A commercial message transmitting and receiving system to transmit and receive commercial message materials comprising;
an advertiser terminal to distribute a plurality of said commercial message materials and a plurality of pieces of commercial message/identification information each corresponding to each of said plurality of said commercial message materials over a same channel and during a same time period;
a broadcast station terminal to create and output a scaled-down and synthesized image obtained by scaling down and synthesizing each of images of said plurality of said commercial message materials and multi-channeled voices obtained by assigning each of voices of said plurality of said commercial message materials to a plurality of voice channels each being different from each other and, at a same time, to synthesize and output said plurality of pieces of said commercial message/identification information;
a transmitting device to modulate said scaled-down and synthesized image and said multi-channeled voices fed from said broadcast station terminal and to transmit them as program data and, at a same time, to modulate and transmit said plurality of pieces of said commercial message/identification information fed from said broadcast station terminal; and
a receiving terminal to display said scaled-down and synthesized image transmitted from said transmitting device and to expand and display, when one commercial message material out of said plurality of said commercial message materials contained in said scaled-down and synthesized images is selected, images of said commercial message material manually selected and, at a same time, to output voices of said voice channels of said commercial message materials manually selected out of said plurality of voice channels contained in said multi-channeled voices.

8. The commercial message transmitting and receiving system according to claim 7, wherein said receiving terminal transmits said commercial message/identification information of said commercial message material and attribute information of said viewer manually selected to said advertiser terminal through a network and wherein said advertiser terminal performs statistical processing of said commercial message/identification information transmitted from said transmitting device and attribute information of said viewer.

9. The commercial message transmitting and receiving system according to claim 7, wherein said transmitting device, when said scaled-down and synthesized image and said multi-channeled voices are transmitted by analog broadcasting, transmits said commercial message/identification information by using a vertical blanking interval and, when said scaled-down and synthesized image and said multi-channeled voices are transmitted by digital broadcasting, transmits said commercial message/identification information as section information or packetized elementary stream information.

10. The commercial message transmitting and receiving system according to claim 8, wherein said receiving terminal comprises:
a viewer attribute setting section to store said attribute information of said viewer input in advance;
a viewer attribute processing section to select one commercial message material out of said plurality of said commercial message materials transmitted as said scaled-down and synthesized image and said multi-channeled voices from said transmitting device;
an image cutting/expanding section to cut and expand images of said commercial message materials selected by said viewer attribute processing section out of images of said plurality of said commercial message materials contained in said scaled-down and synthesized image transmitted from said transmitting device;
a voice channel selecting section to select voice channels of said commercial message materials selected by said viewer attribute processing section out of said plurality of said voice channels contained in said multi-channeled voices transmitted from said transmitting device;
a switching section to select either of said scaled-down synthesized images transmitted from said transmitting device or said images out of images output from said image cutting/expanding section;
a display to display images output from said switching section;
a speaker to output voices of said voice channels selected by said voice channel selecting section;
a selected commercial message database to store said commercial message/identification information of said commercial message materials and said attribute information of said viewers selected by said viewer attribute processing section; and
a communication section to transmit said commercial message/identification information and said attribute information of said viewers stored in said selected commercial message database to said advertiser terminal through said network.

11. The commercial message transmitting and receiving system according to claim 10, wherein said viewer attribute processing section is able to automatically and manually select one commercial message material out of said plurality of said commercial message materials transmitted as said scaled-down and synthesized image and said multi-channeled voices from said transmitting device, based on said plurality of pieces of said commercial message/identification information transmitted from said transmitting device and said attribute information of said viewers stored in said viewer attribute setting section.

12. The commercial message transmitting and receiving system according to claim 10, wherein said advertiser terminal has a statistical processing section of performing statistical processing of said commercial message/identification information and said attribute information of said viewers transmitted from said communication section through said network.

13. A commercial message transmitting and receiving method, comprising:
a step of distributing a plurality of commercial message materials and a plurality of pieces of commercial message/identification information each corresponding to each of said plurality of said commercial message materials over a same channel and during a same time period from an advertiser terminal to a broadcast station terminal;
a step of scaling down and synthesizing each of said plurality of said commercial message materials to create a scaled-down and synthesized image in said broadcast station terminal and outputting said scaled-down and synthesized image to a transmitting device;
a step of assigning each of voices of said plurality of said commercial message materials to voice channels each being different from each other to create multi-channeled voices in said broadcast station terminal and of outputting multi-channeled voices to said transmitting device;
a step of synthesizing said plurality of pieces of said commercial message/identification information in said broadcast station terminal and of outputting them;
a step of modulating, in said transmitting device, said scaled-down and synthesized image and multi-channeled voices fed from said broadcast station terminal and transmitting as program data to a receiving terminal and modulating said plurality of pieces of said commercial message/identification information fed from said broadcast station terminal and outputting them to said receiving terminal;
a step of automatically selecting one commercial message material out of said plurality of said commercial message materials transmitted as said scaled-down and synthesized image and multi-channeled voices from said transmitting device, based on attribute information of viewers and said plurality of pieces of said commercial message/identification information input in advance in said receiving terminal; and
a step of expanding and displaying images of said commercial message materials automatically selected out of images of said plurality of said commercial message materials contained in said scaled-down and synthesized images in said receiving terminal and of outputting voice channels of said commercial message materials automatically selected out of a plurality of said voice channels contained in said multi-channeled voice.

14. The commercial message transmitting and receiving method according to claim 13, further comprising:
a step of storing said commercial message/identification information of said commercial message materials and said attribute information of viewers automatically selected by said receiving terminal;
a step of transmitting said commercial message/identification information of said commercial message materials, said attribute information of viewers automatically selected by said receiving terminal to said advertiser terminal through a network; and
a step of performing statistical processing of said commercial message/identification information and said attribute information of said viewers transmitted from said receiving terminal in said advertiser terminal.

15. The commercial message transmitting and receiving method according to claim 13, wherein said transmitting device, when said scaled-down and said synthesized image and said multi-channeled voices are transmitted by analog broadcasting, transmits said commercial message/identification information by using the vertical blanking interval and, when said scaled-down and said synthesized image and said multi-channeled voices are transmitted by digital broadcasting, transmits said commercial message/identification information as section information or as packetized elementary stream information.

16. A commercial message transmitting and receiving method, comprising:
a step of distributing a plurality of a commercial message materials and a plurality of pieces of a commercial message/identification information each corresponding to each of said plurality of said commercial message materials over a same channel and during a same time period from a advertiser terminal to a broadcast station terminal;
a step of scaling down and synthesizing each of said plurality of said commercial message materials to create a scaled-down and synthesized image in said broadcast station terminal and of outputting said scaled-down and synthesized image to a transmitting device;
a step of assigning each of voices of said plurality of said commercial message materials to a voice channels each being different from each other to create multi-channeled voices in said broadcast station terminal and of outputting said multi-channeled voices to said transmitting device;
a step of synthesizing said plurality of pieces of said commercial message/identification information in said broadcast station terminal and of outputting them;
a step of modulating, in said transmitting device, said scaled-down and synthesized image and said multi-channeled voices fed from said broadcast station terminal and transmitting as program data to a receiving terminal and modulating said plurality of pieces of said commercial message/identification information fed from said broadcast station terminal and outputting them to said receiving terminal;
a step of synthesizing said plurality of pieces of said commercial message/identification information in said broadcast station terminal and of outputting them;
a step of modulating, in said transmitting device, said scaled-down and synthesized image and said multi-channeled voices fed from said broadcast station terminal and transmitting as program data to said receiving terminal and modulating said plurality of pieces of said commercial message/identification information fed from said broadcast station terminal and outputting them to said receiving terminal;
a step of displaying said scaled-down and synthesized image in said receiving terminal;
a step of manually selecting one commercial message material out of said plurality of said commercial message materials contained in said scaled-down and synthesized image displayed by said receiving terminal; and
a step of expanding images of said commercial message materials manually selected out of images of said plurality of said commercial message materials contained in said scaled-down and synthesized image and of outputting voices of said voice channels of said commercial message materials manually selected out of said plurality of said voice channels contained in said multi-channeled voices.

17. The commercial message transmitting and receiving method according to claim 16, further comprising:
a step of storing said commercial message/identification information of said commercial message materials and attribute information of viewers manually selected by said receiving terminal;
a step of transmitting said commercial message/identification information of said commercial message materials and said attribute information of viewers manually selected by said receiving terminal to said advertiser terminal through a network; and
a step of performing statistical processing of said commercial message/identification information and said attribute information of viewers transmitted from said receiving terminal in said advertising terminal.

18. The commercial message transmitting and receiving method according to claim 16, wherein said transmitting device, when said scaled-down and said synthesized image and said multi-channeled voices are transmitted by analog broadcasting, transmits said commercial message/identification information by using the vertical blanking interval and, when said scaled-down and said synthesized image and said multi-channeled voices are transmitted by digital broadcasting, transmits said commercial message/identification information as section information or as packetized elementary stream information.
